(19) United States
(12) Patent Application Publication
(10) Pub. No.: US 2026/0063239 A1
(43) Pub. Date: Mar. 5, 2026

(54) HINGE FREE TILTING DEVICE STAND

(71) Applicant: Lenovo (United States) Inc., Morrisville, NC (US)

(72) Inventors: Julia Young, Raleigh, NC (US); Cyan Godfrey, Chapepl Hill, NC (US)

(21) Appl. No.: 18/817,748

(22) Filed: Aug. 28, 2024

(51) Int. Cl. F16M 11/20

(52) U.S. Cl. CPC F16M 11/2021; F16M 2200/08

(57) ABSTRACT

One embodiment provides a device, including: a base including two indents located at opposite sides of the base, wherein each of the two indents run in a lengthwise direction with respect to a front side and a back side of the base; and a stand including a lower portion and an upper portion, wherein the lower portion includes two substantially parallel arms, wherein each of the two substantially parallel arms fits into one of the two indents of the base, wherein the upper portion connects to a front end of each of the two substantially parallel arms and extends in a non-parallel direction with respect to the two substantially parallel arms. Other aspects are claimed and described.

### BACKGROUND

Modern information handling devices are designed with transportation in mind. Devices have become smaller and lighter permitting a user to carry and/or transport a device with ease. With this downsizing being common across a majority of devices, components that were once standard to a device may no longer be present. For example, a device including a display may no longer include a stand to support a device in an upright position. Additionally, device components that are still present on a device may have also undergone downsizing, for example, the size of a display provided on a device may now be smaller than it was previously. While the removal or size reduction of some components make devices more portable and lightweight, this removal or size reduction may cause the user to be less efficient when utilizing the device.

### BRIEF SUMMARY

In summary, one aspect provides a device, including: a base including two indents located at opposite sides of the base, wherein each of the two indents run in a lengthwise direction with respect to a front side and a back side of the base; and a stand including a lower portion and an upper portion, wherein the lower portion includes two substantially parallel arms, wherein each of the two substantially parallel arms fits into one of the two indents of the base, wherein the upper portion connects to a front end of each of the two substantially parallel arms and extends in a non-parallel direction with respect to the two substantially parallel arms.

Another aspect provides a device, including: a circular-shaped base including two indents located at opposite sides of the base, wherein each of the two indents run in a lengthwise direction with respect to a front side and a back side of the base; and a stand including a lower portion and an upper portion, wherein the lower portion includes two substantially parallel arms connected at a back end of each of the two substantially parallel arms by a connecting piece, wherein each of the two substantially parallel arms fits into one of the two indents of the base; wherein the upper portion includes two substantially parallel legs, each of the two substantially parallel legs connecting to a front end of one of the two substantially parallel arms, the two substantially parallel legs extending in a substantially perpendicular direction with respect to the two substantially parallel arms, wherein each of the two substantially parallel legs includes a plurality of holes located on a front surface of a given of the two substantially parallel legs; and at least two pegs insertable into at least two of the plurality of holes.

A further aspect provides a device, including: a circular-shaped base including an indent located around the circular-shaped base and running in a parallel direction with respect to a top and bottom of the base; and a stand including a lower portion and an upper portion, wherein the lower portion includes two substantially parallel arms connected at a back end of each of the two substantially parallel arms by a connecting piece, wherein each of the two substantially parallel arms fits into the indent of the base as substantially opposite sides of the base, wherein the stand is rotatable within the base via the indent; wherein the upper portion includes two substantially parallel legs, each of the two substantially parallel legs connecting to a front end of one of the two substantially parallel arms, the two substantially parallel legs extending in a non-parallel direction with respect to the two substantially parallel arms, wherein each of the two substantially parallel legs includes a plurality of holes located on a front surface of a given of the two substantially parallel legs; and at least two pegs insertable into at least two of the plurality of holes.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example hinge free tilt stand.

FIG. 4 illustrates example configuration of a hinge free tilt stand.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As devices are continuously transformed and commonly downsized, it may be become more difficult to utilize a device in situations, particularly, a situation when a device is utilized for an extended period of time. A device, such as a tablet, has become a common use device because of the operating power in a smaller, more compact device. However, when a user has to utilize a tablet for an extended period of time, a user may, for example, have to hold the device in an upright position for the entire duration of the time in use, lay the tablet down flat on a surface and stare straight down at the device, and/or prop up the device against another object. Each of these outlined situations may negatively influence a user while utilizing the tablet, and continued use of the tablet in such situations can lead to injury of the user. For example, the user may suffer from muscle and joint strain since these use cases do not promote positive ergonomics.

Traditional, larger devices included stands or bases that could assist with adjusting and holding the viewing angle of a display. However, with the evolution of device design and a desire for portability, many stands or device bases have been removed. Additionally, or alternatively, the evolution of device design incorporates an ability to pair multiple devices together with ease. A seamless transition between paired devices has been a growing standard in all product designs. However, if a user wants to utilize a device in conjunction with another device, for example, a tablet paired with a traditional display, the lack of components of a tablet will make positioning the tablet alongside the display a nuisance. No current solution allows for such an additional device to be positioned on the same viewing level as the display device.

Accordingly, the described systema and method provides a hinge free tilt device stand for information handling device that may be orientated at a variety of angles based upon user preference. The device stand may hold a device at a height and an angle that a user desires, and promotes a comfortable viewing position of the information handling device. The hinge free tilt device stand includes a base, a stand portion that is coupled to the base at a lower portion of the stand, and an upper portion of the stand that may include pegs for height adjustment of an information handling device in use. The base may be a weighted base that may assist in supporting a wide range of information handling devices while also ensuring the stand does not topple over when a device is present on the device stand.

The stand portion of the hinge free tilt stand is also designed in such a way that the lower portion is coupled to the base using a hinge free method that may securely support an attached device at an angle preferred by a user. This hinge free method may be strong in supporting a connected device, yet easy for a user to operate and/or adjust. Additionally, an upper portion of the stand may include a plurality of supporting components and/or an attachment mechanism that both supports the device and permits a height adjustment of a device located on the hinge free tilt stand. These supporting components, for example, pegs present on the upper portion of the stand, may be orientated based on user preference and may be used in combination with an attachment mechanism, for example, the use of magnets, in order to secure a device to the hinge free tilt stand. Therefore, the hinge free tilt stand may supply a user with a secure device stand that will support a variety of information handling devices at a user preferred viewing position.

The illustrated example embodiments will be best understood by reference to the figures. The following description is intended only by way of example, and simply illustrates certain example embodiments.

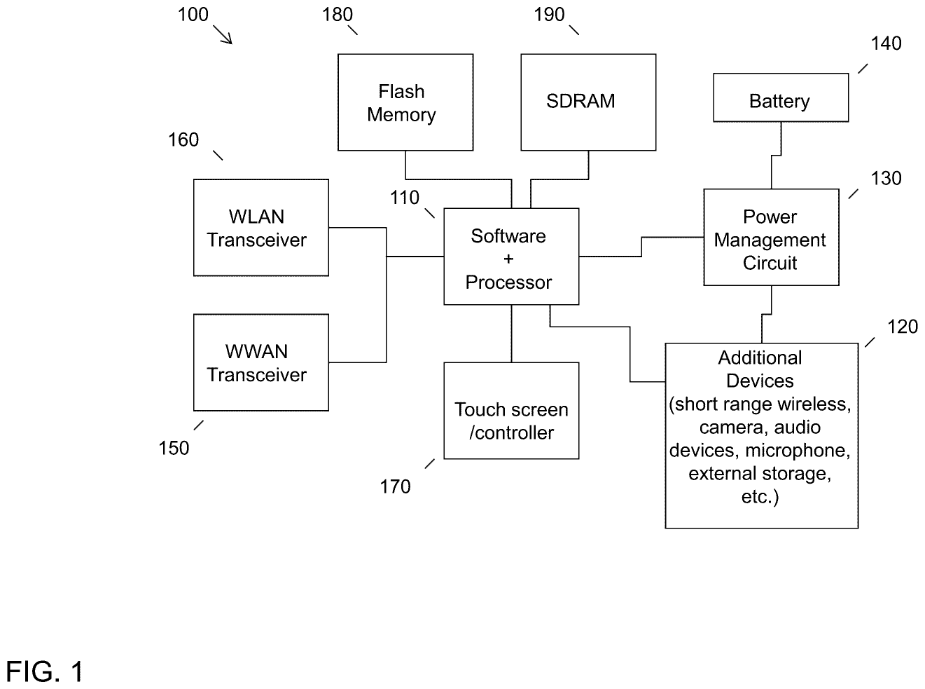

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

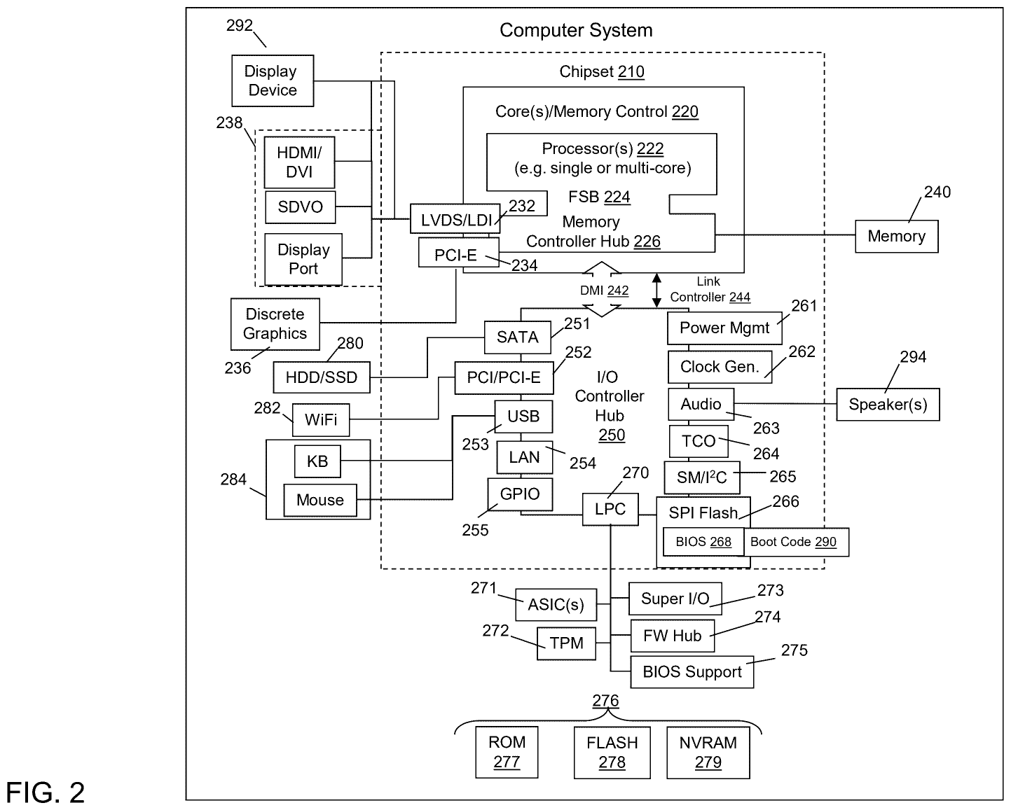

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used with the adjustable information handling device stand. For example, the circuitry outlined in FIG. 1 may be implemented in a tablet or smart phone embodiment, whereas the circuitry outlined in FIG. 2 may be implemented in a personal computer embodiment.

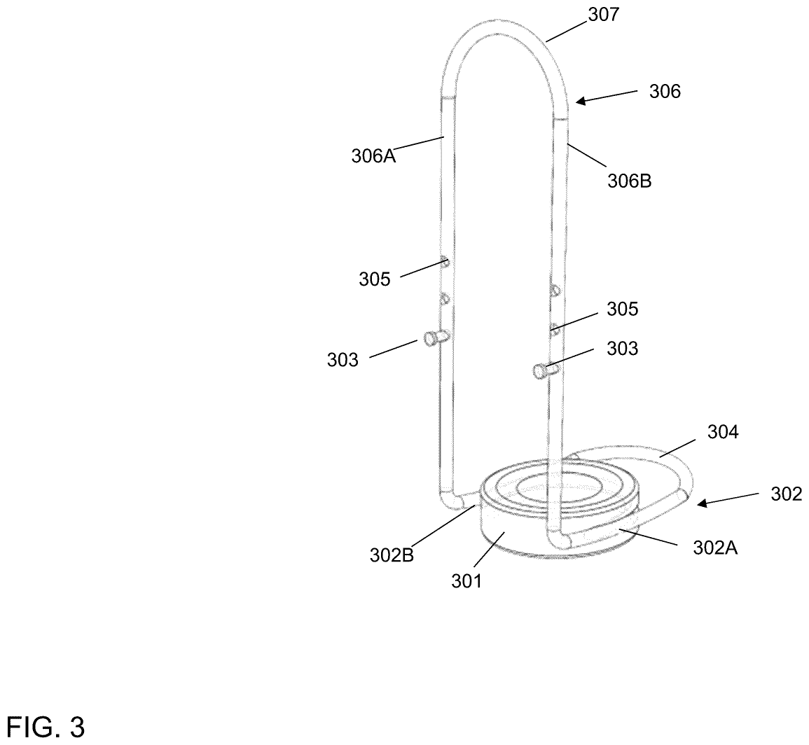

FIG. 3 illustrates an example hinge free tilt device stand. While the system may include known hardware components and/or hardware components developed in the future, the device itself is specifically designed to provide a secure hinge free tilt device stand that may successfully support a variety of information handling devices at orientations aligned with user display preference. Additionally, the hinge free tilt device stand components and features are unique to the described system. Each device stand includes a base and a stand component. The stand component includes an upper portion for height adjustment and support of an information handling device in use, and a lower portion of the stand that is coupled to the base on the hinge free tilt device stand. Throughout the description of the hinge free tilt device stand, the information handling device referred to may be a tablet. However, this is intended as a non-limiting example as the information handling device can be a tablet, cell phone, a smart display, a mobile display with no computing capabilities, a handheld device, and/or the like. The hinge free tilt device stand may be orientated to align with user preference while also supporting a device without issue. Additionally, the stand is of a size and design that allows for easy storage of the stand when not in use.

The stand includes a base 301. The base may have different shapes, sizes, and/or designs. The base of the adjustable information handling device may be weighted to ensure that the stand does not move while in use, for example, toppling over from the weight of the device, moving if a surface that the stand is on moves, and/or the like. In this case, a weighted base is a base having a weight that is at least enough to counteract the weight of a device being attached to the stand. As should be understood, since the device would be attached at an elevated position or cantilevered position, the weight of the base would need to be greater than the weight of the device to counteract the weight of the device at the desired position.

One way to weight the base may be to make a large base or a base having a size to ensure the desired weight is met. However, this would increase the size of the base, which may be undesirable in some applications. Thus, another technique for weighting the base is to make the base of a material having a desired weight. This may allow for a smaller base to be utilized, while still obtaining the desired weight of the base. For example, the base of the device stand may be made from a type of metal (e.g., tungsten, platinum, palladium, etc.), high density plastic, wood, and/or the like, or a combination thereof. The utilization of different materials may allow for different sizes of bases. The base could also be made of one material, which might have one weight, and filled with another material having another weight to get the desired weight.

Additionally, or alternatively, the base may include at least one holding mechanism to attach or hold the base to the surface. The holding mechanism may be used in lieu of or in addition to the weighted base. In other words, instead of a weighted base, the base may be a non-weighted base (i.e., a base not having enough weight to counteract the weight of a device attached to the stand) and instead have holding mechanisms to ensure the stand will not move when a device is attached to the stand. However, the holding mechanism may be used in conjunction with the weighted base. Attaching the base to a surface in which the base lies upon may further assist in securing the hinge free tilt device stand. The holding mechanism may include, for example, a material that may adhere the base to the surface (e.g., a glue-like substance, a sticky strip, tape, and/or the like), a design to increase friction about the bottom of the base (e.g., ridges, a rubber bottom, holding feet, etc.), a suction mechanism, and/or the like, or a combination thereof.

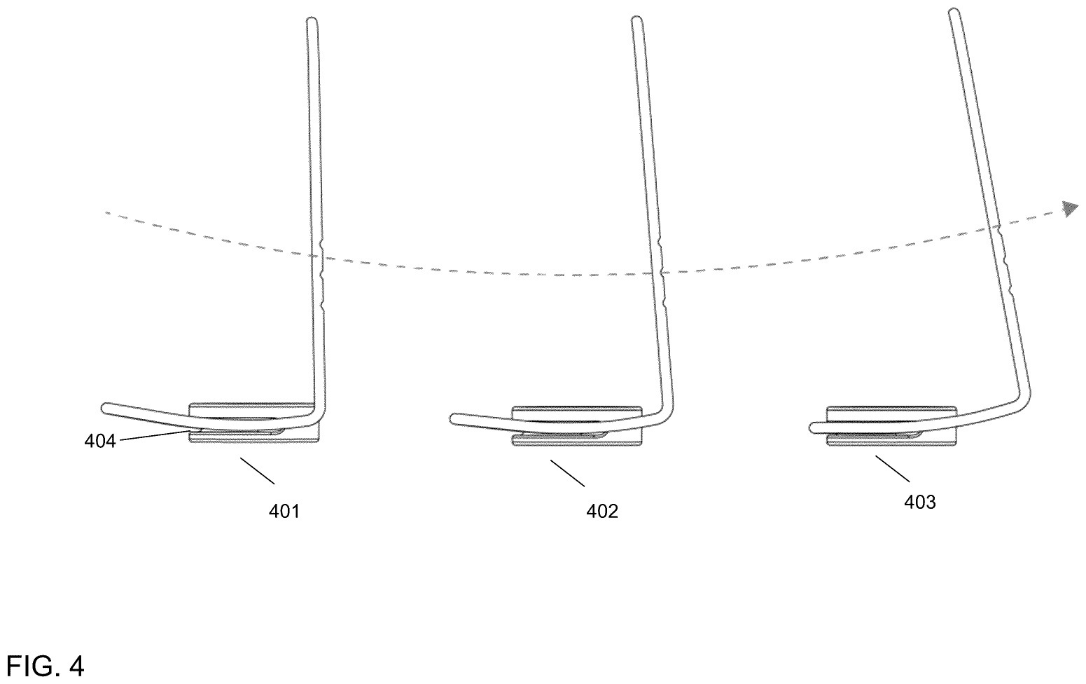

The base may include one or more indents. In the example illustrated in FIG. 3 and FIG. 4, the base includes two indents (one indent is illustrated at 404 in FIG. 4). It should be noted that the two indents may be connected, thereby making a single long indent. However, they will be referred to as two indents for understanding regarding how the stand is coupled to the base. Thus, the term “two indents” is intended to identify two separate portions of the indent where the stand couples to the base and not necessarily a particular number of indents on the base itself. The base may also include an indent that extends around the circumference of the base. In this case, the stand could be rotated about the base in a 360 degree rotation. The two indents are located at substantially opposite sides of the base and run in a lengthwise direction with respect to a front side and a back side of the base. The two indents (or one indent) may be located at a roughly central position in the base with respect to the top and bottom of the base. In other words, the indents may be located in a roughly central location of the base in the vertical direction. The indents may be in a roughly parallel direction with respect to the top and bottom of the base.

The terms front side and back side are relative with respect to the location of the stand on the base. In other words, and particularly if the base has a circular shape, any portion of the base could be the front side and/or back side. Thus, the front side of the base refers to the side or portion of the base that is at the same side or facing the front ends of the lower portion of the stand. The front ends of the lower portion of the stand are the ends where the upper portion connects to the lower portion. The back ends of the lower portion of the stand are the ends opposite the front ends. Accordingly, the back side of the base refers to the side or portion of the base that is substantially opposite the front side of the base.

The stand may be made from a lightweight, durable material. For example, the stand may be made from aluminum, a rigid plastic material, and/or the like. Additionally, or alternatively, the stand may be hollow. A hollow stand may decrease the overall weight of the stand while still allowing a durable material to be used in order to securely hold a coupled information handling device to the hinge free tilt stand. The stand includes a lower portion and an upper portion. The lower portion is the portion of the stand that couples to the base 301. The lower portion of the stand 302 is coupled to the base 301 by use of a hinge free tilt method. The lower portion of the stand 302 may include two substantially parallel arms 302A and 302B. Parallel arms refers to the fact that the arms are roughly parallel to each other and does not refer to the orientation of the arms with respect to other portions of the stand.

Each of the arms 302A and 302B fit into one of the two indents of the base 301. The arms 302A and 302B may be movable through the two indents of the base in a forward and aft direction with respect to the front side and back side of the base. This is illustrated and described in more detail in connection with FIG. 4. Thus, within the two indents of the base 301 may be holding mechanisms that are used to hold the lower portion of the stand 302 within the base 301 at a position selected by the user. In other words, the user can move the stand within the base so as to create a tilt of the upper portion of the stand 306 with respect to the base 301 and the base and/or lower portion of the stand 302 include holding mechanisms that will hold the stand in the position selected by the user.

Different holding mechanisms may be utilized to hold the arms at the desired position within the base. For example, the lower portion of the stand 302 may include a tooth, bump, and/or the like, that aligns with a groove, notch, depression, and/or the like, present within the indents, or vice versa (i.e., the lower portion of the stand includes the depressions and the indents include the bump). As another example, the holding mechanism within the base may be a rotatable, circular mechanism. This circular mechanism may be made from the same durable material as the base (e.g., metal, rigid plastic, etc.), and may include grooves, teeth, and/or the like, permitting the holding of the lower portion of the stand 302 to the base 301. As another example, the indents within the base may include a rubber-like material, silicon-like material, and/or some other material that can create a high friction surface. The material may then “stick” to the arms of the lower portion and hold them in place until a force is applied that can overcome the friction force between the material and the arms. These are merely illustrative examples and are not intended to be limiting.

The holding mechanism allows the user to adjust the stand by moving the arms in a linear motion (forwards and back or fore and aft) about the indent to adjust an angle of the hinge free tilt device stand. When adjusting the lower portion of the stand 302 in a linear fashion, the holding mechanism works to hold the arms of the lower portion in the location or position selected by the user no longer providing force to move the stand with respect to the base. As user adjusts the angle of the hinge free tilt device stand, the linear motion may result in the stand be permitted to move from a totally upright position through a range of angles until reaching a maximum reclined angle. In other words, for example, a totally upright position may have the angle of 0 degrees, or act as a right angle, and a maximum reclined angle may a 25-degree angle tilt. It should be noted that the angle referenced is a viewing angle and thus results from the movement of the upper portion of the stand with respect to the base. Thus, the angle is the angle between the legs of the upper portion of the stand and the base. In order to facilitate the tilting of the stand, the arms may have a slight curve to them in an upward direction, like a smile shape. This curve may assist in obtaining the tilt when the arms are moved through the indents of the base.

The maximum reclined angle, referred to herein as the maximum angle, may be achieved and stopped by a connecting piece 304 of the lower portion of the stand 302 coming in contact with the base 301. The connecting piece 304 is a portion of the stand that connects the two arms of the lower stand at the back end of the arms. This connecting piece 304 may be a curved piece. Specifically, the connecting piece 304 may be of a shape that matches the shape of the base to act as a stopper for the stand. In other words, the connecting piece 304 may include a shape that fits flush against the base 301, for example, as can be seen in FIG. 3, the connecting piece 304 has a partial-circumference shape that may fit flush around the base 301. However, the connecting piece matching the shape of the base is not strictly necessary. In other words, the connecting piece 304 may be any shape that can prevent the stand from being inclined any further past the maximum angle. When the stand is in a totally upright position, and/or at a 0-degree viewing angle, the connecting piece 304 will be at its furthest position from the base 301.

The motion of the stand with respect to the base permits angling the hinge free tilt stand at any angle present between the minimum angle and the maximum angle. In one example, the minimum angle may be 0 degrees and the maximum angle may be 25 degrees. However, this is not strictly necessary as other minimum and maximum angles may be permitted. An angle of less than 0 degrees would result in a downward tilt of the upper portion of the stand as compared to the base. The holding mechanisms may allow an angle adjustment of the stand to any angle that falls between the minimum and maximum angle adjustment. For example, a user may desire viewing a display of a device at an angle of 5-degrees. Additionally, or alternatively, for example, a user may desire viewing a display of a device at an angle of 17-degrees. As long as a desired viewing angle falls within the range of permitted angular adjustment, the system may securely maintain an angle for displaying indefinitely.

The upper portion of the stand 306 encompasses the vertical portion of the stand, whereas, the lower portion of the stand 302 encompasses the horizontal portion of the stand. The upper portion of the stand 306 includes two substantially parallel legs 306A and 306B. Parallel refers to the orientation of the legs with respect to each other and does not refer to the orientation of the legs with respect to any other component. Each of the legs connects to each of the arms of the lower portion 302. More specifically, a bottom end of each of the legs connects to a front end of each of the arms. As illustrated in FIG. 3, there may be an additional component that connects between the leg and arm, but this is not strictly necessary. The legs may extend in a non-parallel direction with respect to the arms. In the example illustrated in the figures, the legs extend in a substantially perpendicular direction with respect to the arms. However, this is not strictly necessary and the legs could be at an angle other than 90 degrees with respect to the arms.

At the opposite end of the legs with respect to the arms, there may be a connection piece 307 that connects the top end of each of the legs. In other words, the upper portion may include a connection piece 307 that connects to two legs at the top of the upper portion. Since this system utilizes a cantilever design, the upper portion of the stand 306 is depicted as being larger than the lower portion of the stand 302. However, this is intended as a non-limiting example and is not strictly necessary.

The upper portion 306 may also include a plurality of holes 305 on a front surface of the legs. In this case, the front surface of the legs corresponds to the front side of the base 301. Each of the legs may include a plurality of holes at different locations on the front surface of the legs. The location of the holes may line up between the two legs. In other words, a hole in one leg may have a corresponding hole at a similar location in the other leg, thereby making the holes at the same height as each other. The device may also include pegs that are insertable within the holes. The pegs 303 in conjunction with the holes 305 are implemented to allow for modification of the height of a device that a user is viewing on the hinge free tilt stand. In FIG. 3, three holes 305 are present along each leg of the stand. In this example, the holes 305 run parallel to each other and are equidistant from one another both vertically and horizontally. In other words, the holes 305 align across the upper portion of the stand. A number of holes 305 present on the upper portion of the stand 306 is not limited to three holes. Rather, in the system, a plurality of holes 305 may be present on the stand, so long as the holes remain aligned with each other.

The pegs 303 act as a support for a device being coupled to the hinge free tilt stand, and more specifically, the upper portion of the stand 306. The pegs 303 act in pairs, and may be positioned at a location that a user prefers. The location of the pegs is commonly based on the size of the information handling device being coupled to the system. The pegs 303 may act as a shelf-like support that a device rests upon. Additionally, or alternatively, the pegs 303 are not limited to this shelf-like orientation, for example, a device may be hung from the pegs, a portion wrapped around the pegs, and/or the like. The pegs 303 may be inserted into the holes 305 using a variety of methods. For example, the pegs 303 may be snapped and/or clipped into the holes 305, the pegs 303 may be screwed into the holes 305, the pegs 303 may be inserted into holes 305 and secured using a secondary piece (e.g., a nut) to maintain connection through the holes 305 to the upper portion of the stand 306, and/or the like, or a combination thereof. The device may also include more than two pegs.

Additionally, or alternatively, in the system, when coupling and/or housing an information handling device on the upper portion of the stand 306, the system may utilize an attachment mechanism. An attachment mechanism may include one or more methods for securely coupling the information handling device to the hinge free tilt stand. The attachment mechanism may be used independently and/or in combination with the pegs 303 and holes 305. For example, the attachment mechanism may utilize magnets present on and/or within the upper portion of the stand 306 that may magnetically adhere the information handling device being viewed by the user. As another example, an attachment mechanism may be one of a plurality of mechanism, for example, an adhesive substance (e.g., a glue-like material, sticky material, putty, etc.), an increased friction material (e.g., silicone, rubber, etc.), and/or the like, present on or in the stand where a device is in contact with the upper portion of the stand 306. Other example attachment mechanisms include mechanical attachment mechanisms (e.g., clip and lock systems, peg and hole systems, etc.), and/or the like. These are merely illustrative examples and are not intended to be limiting. The attachment mechanism may be secure enough to independently secure an information handling device to the hinge free tilt stand. Further, since the angle of hinge free tilt stand may cause a viewable angle of a device to increase, gravity may assist in secure the device to the upper portion of the stand 306.

Additionally, or alternatively, the pegs 303 may employ an attachment mechanism to assist with securing an information handling device to the hinge free tilt stand. The attachment mechanism present on or within the pegs 303 may include, for example, magnets incorporated within the pegs 303. Other attachment mechanisms that may be incorporated on or within the pegs includes those previously discussed with respect to the attachment mechanism on or within the stand. Along with supporting a device that rests upon the pegs 303, the attachment mechanism present within the pegs 303 may add additional support for anchoring and securing an information handling device to the upper portion of the stand 306. The use of magnetic pegs 303 is intended as a non-limiting example, as a variety of attachment mechanisms may be worked directly into the pegs 303 present on the system.

Referring now to FIG. 4, an example configuration of a hinge free tilt device stand is provided. FIG. 4 illustrates a side view of the hinge free tilt device stand where the stand is at three different angular positions. Additionally, a side illustration of the indent in the base 404 is also provided. The arrow directed across the three representations is showing how a stand is moving in comparison to the angle provided by the stand. At 401, FIG. 4 illustrates a hinge free tilt device stand that is at a minimum angle and/or is totally upright. As mentioned above, such a position may be determined to have a 0-degree angle, and/or being a right angle. 401 shows that has the upper portion of the stand is totally upright and the distance of the connecting piece of the lower portion of the stand is at its furthest point from the base of the hinge free tilt device stand. Moving towards 402, as the arrow across the figure shows, the angle of the upper portion of the stand with respect to the base is increasing as the distance between the connecting piece of the lower portion moves closer to the base.

402 represents an angle of the stand that may fall within the range of angles between the minimum angle and the maximum angle. For example, in the described example of a minimum angle of 0 degrees and a maximum angle of 25 degrees, the angle may be any angle or portion thereof between the minimum and maximum angles. Then, as the angle of the upper portion of the stand reaches the maximum angle, as shown in 403, the distance between the connecting piece of the lower portion of the stand and the base is closed, and/or the connecting piece is in contact with the back side of the base.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.”Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A device, comprising:
a base comprising two indents located at opposite sides of the base, wherein each of the two indents run in a lengthwise direction with respect to a front side and a back side of the base; and
a stand comprising a lower portion and an upper portion, wherein the lower portion comprises two substantially parallel arms, wherein each of the two substantially parallel arms fits into one of the two indents of the base, wherein the upper portion connects to a front end of each of the two substantially parallel arms and extends in a non-parallel direction with respect to the two substantially parallel arms.

2. The device of claim 1, wherein the stand further comprises a plurality of holes located on a front surface of the upper portion.

3. The device of claim 2, further comprising at least two pegs insertable into at least two of the plurality of holes.

4. The device of claim 1, wherein the lower portion comprises a connecting piece connecting the two substantially parallel arms at a back end of each of the two substantially parallel arms.

5. The device of claim 4, wherein the connecting piece comprises a curved piece.

6. The device of claim 1, wherein the upper portion of the stand comprises two substantially parallel legs, wherein the upper portion connecting to the front end of the each of the two substantially parallel arms comprises a bottom end of each of the two substantially parallel legs connecting to the front end of the each of the two substantially parallel arms.

7. The device of claim 1, wherein the non-parallel direction comprises a substantially perpendicular direction.

8. The device of claim 1, wherein the lower portion of the stand is movable through the two indents of the base in a forward and aft direction with respect to the front side and back side of the base.

9. The device of claim 1, further comprising at least one attachment mechanism located in the upper portion.

10. The device of claim 1, wherein the stand comprises a tubular design.

11. The device of claim 1, wherein the indents comprise holding mechanisms to hold the lower portion of the stand at a user selected position within the base.

12. A device, comprising:
a circular-shaped base comprising two indents located at opposite sides of the base, wherein each of the two indents run in a lengthwise direction with respect to a front side and a back side of the base; and
a stand comprising a lower portion and an upper portion, wherein the lower portion comprises two substantially parallel arms connected at a back end of each of the two substantially parallel arms by a connecting piece, wherein each of the two substantially parallel arms fits into one of the two indents of the base;
wherein the upper portion comprises two substantially parallel legs, each of the two substantially parallel legs connecting to a front end of one of the two substantially parallel arms, the two substantially parallel legs extending in a substantially perpendicular direction with respect to the two substantially parallel arms, wherein each of the two substantially parallel legs comprises a plurality of holes located on a front surface of a given of the two substantially parallel legs; and
at least two pegs insertable into at least two of the plurality of holes.

13. The device of claim 12, wherein one of the at least two pegs is inserted into one of the plurality of holes of one of the two substantially parallel legs and wherein another of the at least two pegs is inserted into a corresponding one of the plurality of holes of the other of the two substantially parallel legs, wherein an information handling device is positionable on the stand via the at least two pegs.

14. The device of claim 12, wherein the connecting piece comprises a curved piece.

15. The device of claim 12, wherein the lower portion of the stand is movable through the two indents of the base in a forward and aft direction with respect to the front side and back side of the base.

16. The device of claim 12, further comprising at least one attachment mechanism located in the upper portion.

17. The device of claim 12, wherein the stand comprises a tubular design.

18. The device of claim 12, wherein the indents comprise holding mechanisms to hold the lower portion of the stand at a user selected position within the base.

19. The device of claim 12, wherein the upper portion comprises a curved connection piece connecting a top end of each of the substantially parallel legs.

20. A device, comprising:
a circular-shaped base comprising an indent located around the circular-shaped base and running in a parallel direction with respect to a top and bottom of the base; and
a stand comprising a lower portion and an upper portion, wherein the lower portion comprises two substantially parallel arms connected at a back end of each of the two substantially parallel arms by a connecting piece, wherein each of the two substantially parallel arms fits into the indent of the base as substantially opposite sides of the base, wherein the stand is rotatable within the base via the indent;
wherein the upper portion comprises two substantially parallel legs, each of the two substantially parallel legs connecting to a front end of one of the two substantially parallel arms, the two substantially parallel legs extending in a non-parallel direction with respect to the two substantially parallel arms, wherein each of the two substantially parallel legs comprises a plurality of holes located on a front surface of a given of the two substantially parallel legs; and
at least two pegs insertable into at least two of the plurality of holes.
